(19) United States
(12) Patent Application Publication
(10) Pub. No.: US 2010/0175355 A1
(43) Pub. Date: Jul. 15, 2010

(54) Vine stripping apparatus and method

(76) Inventors: Kerry T. Desmarais, Sunnyside, WA (US); Thomas Carpenter, JR., Granger, WA (US); Craig A. Carpenter, Granger, WA (US)

Correspondence Address: Michelle Bos Legal LLC, P.O. Box 803, Zillah, WA, 98953, US

(21) Appl. No.: 12/319,984

(22) Filed: Jan. 13, 2009

(51) Int. Cl. A01D 46/00

(52) U.S. Cl. 56/10.7; 56/330; 56/14.7; 56/11.9; 460/134

(57) ABSTRACT

An apparatus for removing plant material from a vine. The apparatus generally comprises a support frame, a pair of counter-rotating wheels, and a vine stripping component. In an embodiment, the vine stripping component includes interchangeable threaded stripping dies. In an additional embodiment, the apparatus is incorporated in a mobile harvesting unit. The invention further includes a method for removing plant material from vines.

### CROSS-REFERENCE TO RELATED APPLICATIONS

None

### BACKGROUND OF THE INVENTION

The invention claimed herein relates to the field of harvesting equipment. More particularly, the invention relates to a device for removing plant material from a vine so that the vine can be discarded and only the desirable plant material retained for processing. The invention is particularly useful in the harvest of hops cones (“hops”) from hop vines.

Hop vines are grown on a trellis. The young hop plant is trained to grow up a support twine secured in the ground at the lower end, and to a horizontal wire at the upper end. At harvest, the hops are removed from the vines and are processed to extract components used in making beer and other products. A variety of devices have been used to harvest hops. Some provide for picking of the hops in the field. The most commonly used devices in commercial hop harvesting provide for the removal and transport of the entire hop vine and support twine to a central processing facility. At the processing facility, the hop vines are suspended one by one on a series of hooks that carry the vines into a chamber. Each vine is “combed” or “raked” to strip off the leaves and cones, which fall to a screen or conveyor. A number of processes are known for separating the cones from the leaves, stems and other debris once they are removed from the vine.

While the process described above is effective in harvesting hops, it is not ideal. One shortcoming of this process is that the vines, support twine, leaves and stems must be transported from the field to the processing facility along with the hops. Once the hops are successfully separated, the rest of the plant and support twine are destroyed. It would be advantageous to leave the unusable parts of the plant in the field rather than to incur the additional labor and transportation costs to transport them to a processing facility.

Another shortcoming of known hop harvesting devices is that it is not uncommon for hops to be missed in the harvesting process, resulting in a lower crop yield than might be possible with a more thorough harvesting device.

It is therefore an object of the present invention to provide a vine stripping apparatus useful in harvesting hops and other vine-grown agricultural products that is efficient and thorough in removal of the hops from the vine. It is a further object of the present invention to provide a vine stripping apparatus that is useful in the field, as well as at a central processing location. These objectives and others are met by the invention described in the following specification, and in the accompanying drawings.

### BRIEF SUMMARY OF THE INVENTION

The invention claimed and described herein comprises an apparatus for removing plant material from a vine. The apparatus generally comprises a support frame, a pair of counter-rotating wheels, and a vine stripping component. In an embodiment, the vine stripping component includes interchangeable threaded stripping dies. In an additional embodiment, the apparatus is incorporated in a mobile harvesting unit. The invention further includes a method for removing plant material from vines.

### BRIEF DESCRIPTION OF THE SEVERAL VIEWS OF THE DRAWING

FIG. 1 is a front elevation view of the vine stripping apparatus of the present invention;

FIG. 2 is a front elevation view of the vine stripping apparatus of the present invention, shown in cut-away view;

FIG. 3 is a rear elevation view of the vine stripping apparatus of the present invention;

FIG. 4 is a side section view of the vine stripping apparatus of present invention;

FIG. 5 is a plan view of a first embodiment of a threaded stripping die of the present invention;

FIG. 6 is a plan view of a second embodiment of a threaded stripping die of the present invention;

FIG. 7 is a plan view of a third embodiment of a threaded stripping die of the present invention;

FIG. 8 is a side view of a threaded stripping die of the present invention;

FIG. 9 is a side elevation view of an embodiment of the vine stripping apparatus, shown mounted on a mobile harvesting unit suitable for use in a hop field, and;

FIG. 10 is a rear elevation view of an embodiment of the vine stripping apparatus, shown mounted on a mobile harvesting unit suitable for use in a hop field.

### DETAILED DESCRIPTION OF THE INVENTION

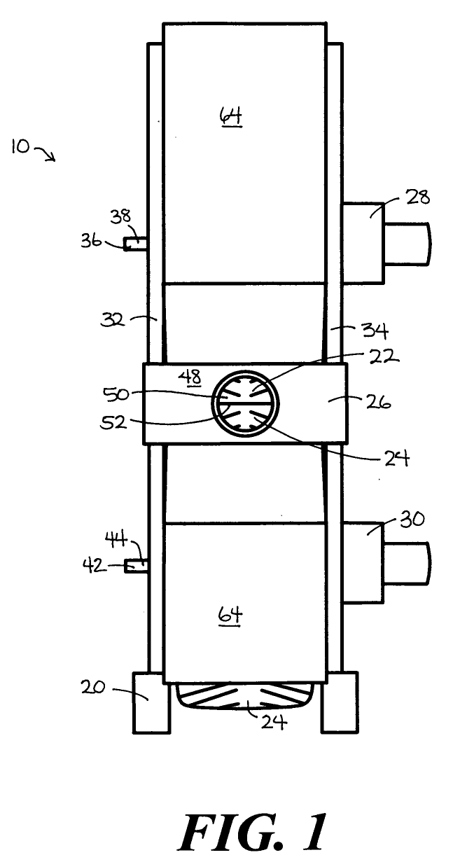

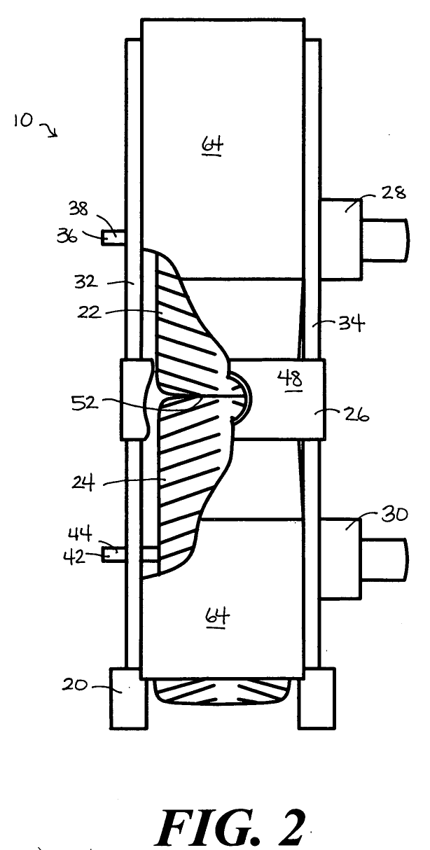

The vine stripping apparatus claimed herein is shown in the attached drawings. With reference to FIGS. 1 and 2, the vine stripping apparatus 10 comprises a support frame 20, two counter-rotating wheels 22 and 24, a vine stripper 26, and wheel rotating means 28 and 30.

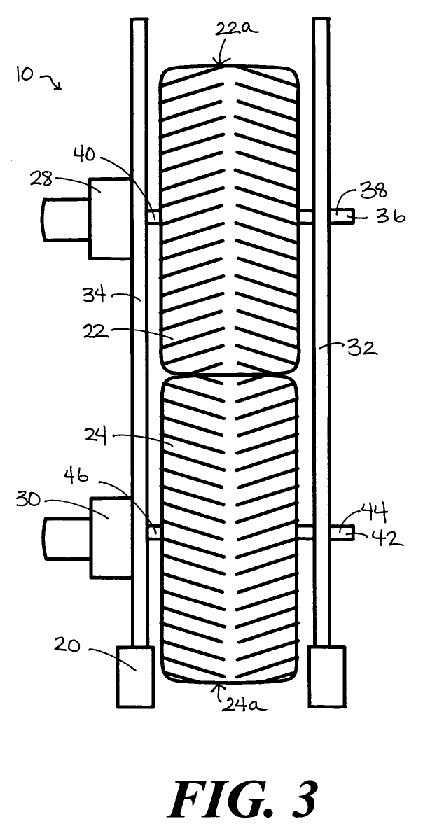

The support frame 20 comprises a structure for supporting the counter-rotating wheels 22, 24. A preferred embodiment of the support frame is shown in FIGS. 1 through 3, 9 and 10. In this embodiment, the support frame consists of a first support rail 32 and a second support rail 34, wherein the first and second support rails are substantially parallel to one another. In the embodiment shown in the drawings, the support frame is substantially vertically oriented. However, it is contemplated that the support frame may be positioned in any orientation that is convenient for the particular application. It is further contemplated that the support frame may be configured in any number of ways, so long as the support frame is adapted to receive the counter-rotating wheels in the relative position as described herein.

A pair of counter-rotating wheels are mounted on the support frame 20. In the preferred embodiment shown in the drawings, the counter-rotating wheels include a first wheel 22 having a first lateral surface 22a, and a second wheel 24 having a second lateral surface 24a. In a preferred embodiment, the counter-rotating wheels comprise inflatable tires, such as conventional automotive tires, mounted on conventional automotive wheels. Conventional automotive tires and wheels, as shown in the drawings, are especially suitable for carrying out the invention because the pressure in the tires can be adjusted to an optimum level. However, any wheel having a pliable lateral surface could be used in place of the automotive tire and wheel as described and shown herein, and is considered to be within the scope of the invention. According to the invention, at least one of the wheels has a pliable lateral surface.

The first wheel 22 and the second wheel 24 are rotatably secured to the support frame 20 on a first axle 36 and a second axle 42, respectively. The first axle has a first end 38 and a second end 40. The second axle has a first end 44 and a second end 46. Each axle first end is rotatably secured to the first support rail 32 of the support frame. Each axle second end is functionally engaged with the wheel rotating means 28, 30 mounted on the second rail 34 of the support frame. The first axle and the second axle are parallel to and spaced apart from one another, such that the lateral surfaces 22a, 24a of the counter-rotating wheels are in substantial contact with one another, as shown in FIGS. 2, 3 and 4.

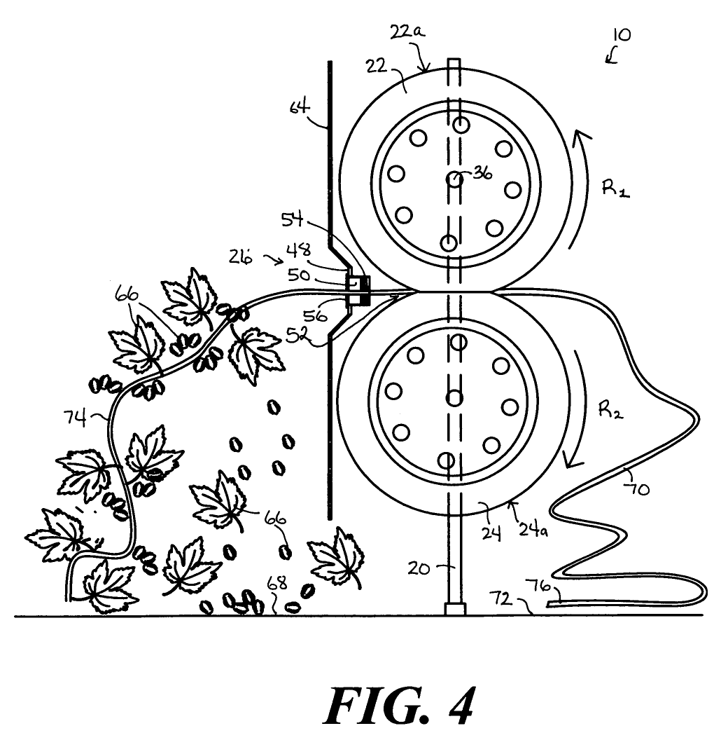

In a preferred embodiment, the vine stripper 26 is affixed to the support frame 20, although this is not a requirement of the invention. A freestanding or alternative support for the vine stripper may also be employed. The vine stripper comprises at least one stripping orifice plate 48. At least one stripping orifice 50 is formed in the stripping orifice plate. As shown in FIGS. 1, 2 and 4, the stripping orifice plate is positioned between the first axle 36 and the second axle 44, centered proximate a contact point 52 where the first lateral surface 22a of first wheel 22 and the second lateral surface 24a of second wheel 24 contact one another. Preferably, the stripping orifice is located in close proximity to the contact point 52, as best seen in FIG. 4. In an embodiment in which the wheels are approximately 24 inches in diameter and approximately 8½ inches in width, placement of the stripping orifice approximately 6 inches from the contact point is ideal. The stripping orifice is large enough to allow a vine and support twine to pass through, but small enough to prevent the passage of the majority of leaves and other plant material, such as hops. The stripping orifice is also sized to prevent the operator's hand from inadvertently being pulled through.

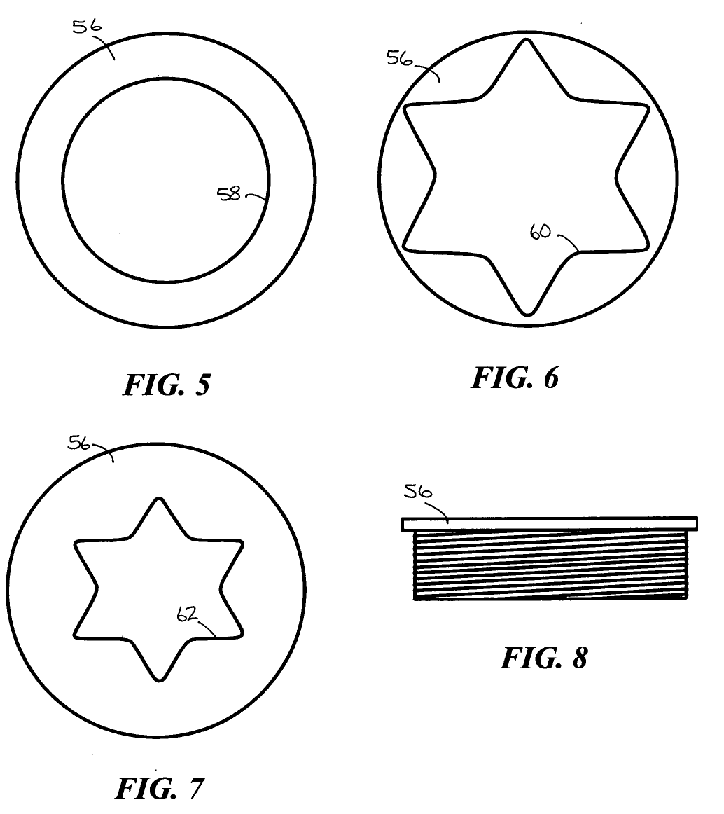

Preferably, the stripping orifice 50 comprises a threaded opening 54 in the stripping orifice plate 48, and a complementary threaded stripping die 56 receivable in the threaded opening. In this embodiment, several interchangeable stripping dies, such as the ones shown in FIGS. 5, 6 and 7 and 8, can be employed. The size and configuration of the stripping die can be matched to the particular species or variety of plant being harvested. The circular opening 58 of the threaded stripping die shown in FIG. 5, and the “star” shaped openings 60 and 62 of the threaded stripping dies shown in FIGS. 6 and 7 have been used with success with hop vines.

The purpose of the counter-rotating wheels, first wheel 22 and second wheel 24, is to grasp and pull the vine and twine through the stripping orifice 50. In order to accomplish this pulling action, the first wheel 22 is rotated in a first direction R₁, and the second wheel 24 is rotated in a second direction R₂, opposite the first direction. The counter-rotation of the wheels is best shown in FIG. 4, wherein it can be seen that the first wheel is rotated in a counterclockwise direction, and the second wheel is rotated in a clockwise direction. The result of the counter-rotational relationship of the wheels is that at the contact point 52, both wheels are rotating in a direction away from the stripping orifice 50.

The rotating means 28 and 30 shown in FIGS. 1 through 4 provide power to effect the rotation of the wheels 22, 24 as described above. In a preferred embodiment, the rotating means are hydraulic motors, although other types of power sources are contemplated, including electric power, combustible fuel, and manual power.

In a preferred embodiment shown in FIGS. 1 and 2, the vine stripping apparatus 10 further includes a cowling 64, which provides a safety barrier to protect the operator from the rotating wheels 22, 24.

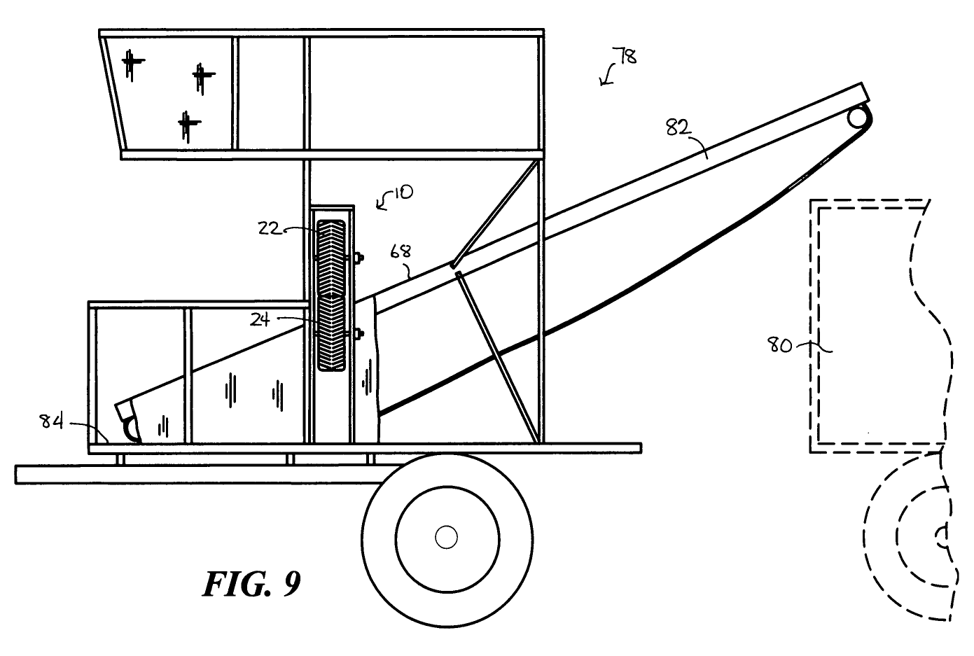

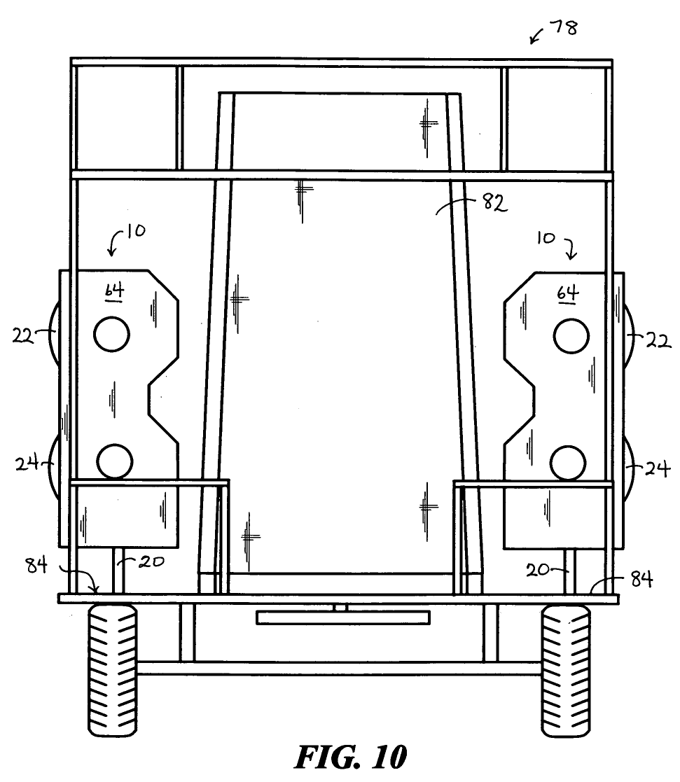

In use, the vine stripping apparatus 10 rapidly and thoroughly removes substantially all plant material 66 from a vine and deposits it in a collection location 68, and ejects the stripped vine 70 in a disposal location 72. See FIGS. 4 and 9. The process of stripping a vine using the vine stripping apparatus described herein includes first obtaining an unstripped vine 74 that has been severed from its root. As referred to herein, an “unstripped vine” is a vine that has not been stripped of leaves and other plant material, and may or may not include the support twine on which the vine was grown. In the case of hop vines, both the root end and trellis end of the vine and twine must be severed, leaving a completely detached unstripped vine. The wheel rotating means 28, 30 are engaged to turn first wheel 22 in direction R₁ and second wheel 24 in direction R₂. The root end 76 of the unstripped vine is inserted into the stripping orifice 50 until it reaches the wheel contact point 52. As the wheels turn, the root end of the unstripped vine is grasped between the wheels and the vine is pulled through the stripping orifice. Plant material 66 growing on the vine is too bulky to pass through the stripping orifice, and is therefore pulled off of the vine by the stripping orifice and deposited in the collection location 68. As the unstripped vine is continuously advanced, it is stripped clean and the stripped vine 70 is deposited in the disposal location 72. The stripping process occurs rapidly—under ideal conditions, approximately thirty 18-foot vines can be stripped per minute.

An advantage of the process described herein is that nearly all of the plant material 66 is removed from the vine, resulting in very little waste. An additional advantage of the process is that the plant material sustains very little damage during this stripping process. This is due to the “self-cushioning” effect that results as the vine passes through the stripping orifice 50. The plant material tends to accumulate against the stripping orifice, forming a cushion against which additional plant material is pressed as the vine is pulled through.

In an embodiment of the invention, at least one vine stripping apparatus 10 is mounted to a mobile harvesting unit 78 suitable for use in the field where the crop to be harvested is grown. The mobile harvesting unit is used in combination with a receptacle 80 for collecting the harvested plant material 66 and transporting it to a central processing facility for further sorting and processing. The mobile harvesting unit may be adapted to be towed by another powered vehicle, as shown in FIGS. 9 and 10, or it may include an integrated power source for moving through the field. In addition, the mobile harvesting unit or the powered vehicle may include a power source for providing power to the rotating means 28, 30 of the vine stripping apparatus.

The mobile harvesting unit 78 is adapted to receive one or more vine stripping apparatuses, as shown generally in FIGS. 9 and 10. A conveyor 82 is provided in the bed of the vehicle for receiving the plant material 66 and carrying it to be deposited in the receptacle 80. Each vine stripping apparatus 10 is positioned on the vehicle so that the vine stripper 26 is substantially oriented toward the conveyor. An operator platform 84 in the vehicle provides a secure location for the operator to stand as he or she feeds unstripped vines 74 into the vine stripping apparatus 10.

In compliance with the statutes, the invention has been described in language more or less specific as to structural features and process steps. While this invention can be embodied in different forms, the specification describes and illustrates preferred embodiments of the invention. It is to be understood that this disclosure is an exemplification of the principles of the invention, and is not intended to limit the invention to the particular embodiments described. Those with ordinary skill in the art will appreciate that other embodiments and variations of the invention, which employ the same inventive concepts as the invention, are possible. Therefore, the invention is not to be limited except by the following claims, as appropriately interpreted in accordance with the doctrine of equivalents.

1. An apparatus for removing plant material from a vine, the apparatus comprising:
a support frame;
a first wheel mounted on the support frame, the first wheel having a first lateral surface, and a second wheel mounted on the support frame, the second wheel having a second lateral surface, wherein the first lateral surface and the second lateral surface are in substantially full contact at a contact point;
a first wheel rotating means for rotating the first wheel in a first direction;
a second wheel rotating means for rotating the second wheel in a second direction opposite the first direction; and
a vine stripper, the vine stripper comprising a stripping orifice plate having a stripping orifice formed therein, wherein the stripping orifice is proximate the contact point of the first lateral surface and the second lateral surface, and wherein the stripping orifice comprises a threaded opening, and further comprises a complementary threaded stripping die receivable in the threaded opening, the complementary threaded stripping die having an opening therein for receiving a vine.

2. The apparatus of claim 1, wherein at least the first lateral surface or the second lateral surface is pliable.

3. The apparatus of claim 1, wherein the first wheel and the second wheel are comprised of inflatable tires mounted on wheels.

4. The apparatus of claim 1, wherein the wheel rotating means comprises a hydraulic motor.

5. (canceled)

6. The apparatus of claim 1, wherein the opening of the complementary threaded stripping die is substantially circular in shape.

7. The apparatus of claim 1, wherein the opening of the complementary threaded stripping die is substantially star-shaped.

8. A mobile harvesting unit comprising:
a wheeled platform;
a means for moving the wheeled platform;
at least one vine stripping apparatus, the apparatus comprising a support frame mounted on the wheeled platform; a first wheel mounted on the support frame, the first wheel having a first lateral surface, and a second wheel mounted on the support frame, the second wheel having a second lateral surface, wherein the first lateral surface and the second lateral surface are in substantially full contact at a contact point; a first wheel rotating means for rotating the first wheel in a first direction; a second wheel rotating means for rotating the second wheel in a second direction opposite the first direction; and a vine stripper, the vine stripper comprising a stripping orifice plate having a stripping orifice formed therein, wherein the stripping orifice is proximate the contact point of the first lateral surface and the second lateral surface, and wherein the stripping orifice comprises a threaded opening, and further comprises a complementary threaded stripping die receivable in the threaded opening, the complementary threaded stripping die having an opening therein for receiving a vine; and,
a conveyor mounted on the wheeled platform, the conveyor having a first end located proximate the vine stripping apparatus, and a second end extending beyond the wheeled platform.

9. The mobile harvesting unit of claim 8, wherein the means for moving the wheeled platform is a powered vehicle, and the wheeled platform is adapted to be removably secured to and towed by the powered vehicle.

10. The mobile harvesting unit of claim 8, wherein the means for moving the wheeled platform is a power source integrated in the mobile harvesting unit.

11. A method for removing plant material from a vine using a vine stripping apparatus, the vine stripping apparatus comprising a support frame; a first wheel mounted on the support frame, the first wheel having a first lateral surface, and a second wheel mounted on the support frame, the second wheel having a second lateral surface, wherein the first lateral surface and the second lateral surface are in substantially full contact at a contact point; a first wheel rotating means for rotating the first wheel in a first direction; a second wheel rotating means for rotating the second wheel in a second direction opposite the first direction; and a vine stripper, the vine stripper comprising a stripping orifice plate having a stripping orifice formed therein, wherein the stripping orifice is proximate the contact point of the first lateral surface and the second lateral surface, and wherein the stripping orifice comprises a threaded opening, and further comprises a complementary threaded stripping die receivable in the threaded opening, the complementary threaded stripping die having an opening therein for receiving a vine; the method comprising the steps of:
selecting a vine having an end that has been severed near the root;
engaging the wheel rotating means to simultaneously rotate the first wheel in the first direction, and the second wheel in the second direction;
inserting the vine end through the stripping orifice until it reaches the contact point; and
allowing the wheels to grasp the vine end and pull the vine through the stripping orifice, resulting in the detachment of plant material from the vine as the vine passes through the stripping orifice.

12. The method of claim 11, wherein the vine stripping apparatus further comprises a conveyor, and the method further comprises the step of allowing the plant material to fall onto the conveyor as it is detached from the vine.

13. The method of claim 12, further comprising the step of advancing the plant material on the conveyor to a collection location.
